(19) United States
(12) Patent Application Publication
(10) Pub. No.: US 2010/0095115 A1
(43) Pub. Date: Apr. 15, 2010

(54) FILE ENCRYPTION WHILE MAINTAINING FILE SIZE

(75) Inventor: Eric Murray, Los Gatos, CA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(73) Assignee: SafeNet, Inc., Belcamp, MD (US)

(21) Appl. No.: 12/448,577

(22) PCT Filed: Jan. 28, 2008
(86) PCT No.: PCT/US08/52227

§ 371 Date: Jun. 24, 2009

Related U.S. Application Data
(60) Provisional application No. 60/897,577, filed on Jan. 26, 2007.

(51) Int. Cl. H04L 9/00

(52) U.S. Cl. 713/165

(57) ABSTRACT

A technique for encrypting a file without changing file size may involve encrypting a first set of a plurality of blocks of a file in a first encryption mode using the first set of encryption keys and/or the first set of configuration rules, and a second set of the plurality of blocks of the file in a second encryption mode using a second set of the encryption keys and/or a second set of the configuration rules without causing the file to increase in size before and after the encryption. Here, the first and the second encryption modes are chosen to be different, so are the first and the second sets of the encryption keys and/or the configuration rules to reduce security risk of the file being encrypted.

### BACKGROUND

When a file is encrypted, the encryption may change the size of the file. This may have some undesirable effects. For example, an operating system may work with block sizes of, e.g., 512 bytes. Where encryption adds n additional bytes to a particular 512 byte block, the file system would have to grab two blocks in order to get that particular block, plus the encryption overhead. This can have significant deleterious effects on caching systems that cache blocks of data. As another example, a file utility may allow a seek into a file. If the seek adds 1 megabyte into a file, and there is additional padding from encryption overhead, then the operating system will have to do some additional calculations to take into account the encryption overhead. These are but two examples of why changing file size with encryption can be troublesome. An exhaustive list is not attempted herein.

Stream ciphers may be used to encrypt files without changing file size, but stream ciphers have problems. For example, security can be compromised if the same stream cipher key is used to encrypt a file twice. For this reason, a stream cipher must use a different key every time a file is encrypted.

These are but a subset of the problems and issues associated with file encryption, and are intended to characterize weaknesses in the prior art by way of example. The foregoing examples of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools, and methods that are meant to be exemplary and illustrative, not limiting in scope. In various embodiments, one or more of the above-described problems have been reduced or eliminated, while other embodiments are directed to other improvements.

A technique for encrypting a file without changing file size may involve encrypting a first set of a plurality of blocks of a file in a first encryption mode using the first set of encryption keys and/or the first set of configuration rules, and a second set of the plurality of blocks of the file in a second encryption mode using a second set of the encryption keys and/or a second set of the configuration rules without causing the file to increase in size before and after the encryption. Here, the first and the second encryption modes are chosen to be different, so are the first and the second sets of the encryption keys and/or the configuration rules to reduce security risk of the file being encrypted.

The proposed system can offer, among other advantages, encrypted files that are the same size as the unencrypted files. This and other advantages of the techniques described herein will become apparent to those skilled in the art upon a reading of the following descriptions and a study of the several figures of the drawings.

### BRIEF DESCRIPTION OF THE DRAWINGS

Embodiments of the invention are illustrated in the figures. However, the embodiments and figures are illustrative rather than limiting; they provide examples of the invention.

FIG. 1 depicts an example of a system including a file encryption engine.

FIG. 2 depicts an example of an encrypted file.

FIGS. 3A and 3B depict examples of how to respectively encrypt and decrypt chained ciphertext block(s) in cipher block chaining (CBC) mode encryption.

FIGS. 4A and 4B depict examples of how to respectively encrypt and decrypt streamed ciphertext block(s) in cipher feedback (CBF) mode encryption.

FIG. 5 depicts a flowchart 500 of an example of a method for encrypting a file.

### DETAILED DESCRIPTION

In the following description, several specific details are presented to provide a thorough understanding of embodiments of the invention. One skilled in the relevant art will recognize, however, that the invention can be practiced without one or more of the specific details, or in combination with other components, etc. In other instances, well-known implementations or operations are not shown or described in detail to avoid obscuring aspects of various embodiments, of the invention.

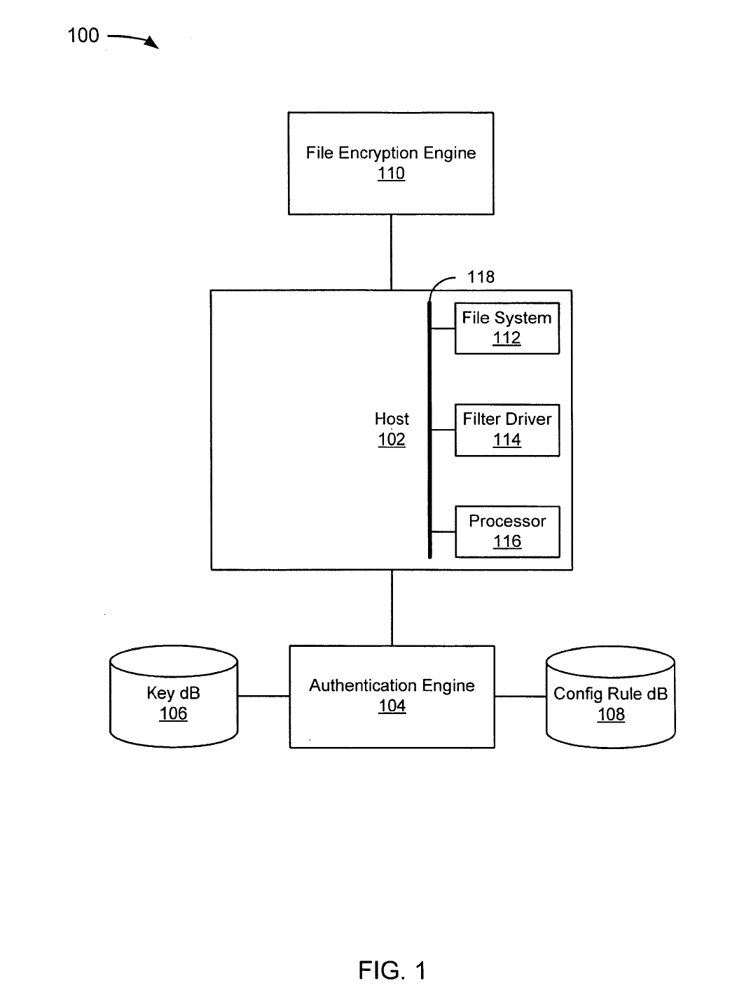

FIG. 1 depicts an example of a system 100 to support file encryption. The system 100 includes a host 102, an authentication engine 104, a key database 106, a config rule database 108, and a file encryption engine 110.

The host 102 may include any known or convenient computer system. The host 102 may function as a file server or have some other functionality. In an illustrative embodiment, the host 102 includes a file system 112, a filter driver 114, and a processor 116 coupled to a bus 118. The functionality of the file system 112, filter driver 114, processor 116, and bus 118 are well-known in the relevant art, so a detailed description of these components is deemed unnecessary. It may be noted that bus-less architectures may be used in alternative embodiments.

Conceptually, the filter driver 114 is inserted, as part of the operating system, between the file system 112 and a process that will use files from the file system 112. The filter driver 114 applies the configuration rules provided from the config rule database 108 by the authentication engine 104. The configuration rules may include, by way of example but not limitation, a rule that everything in a first directory is to be encrypted using a first key provided from the key database 106 by the authentication engine 104. (Alternatively, the first key could be generated locally or received from some place other than the key database 106.) As another example, the configuration rules may include a rule that a first user receives encrypted data (e.g., cipher text) when accessing a particular file.

The authentication engine 104 may include any known or convenient computer system. The authentication engine 104 may or may not be implemented as an appliance that is coupled to the host 102, or as some other device or computer coupled to the host 102 through, e.g., a network connection. The authentication engine 104 provides keys and configuration (encryption) rules from the key database 106 and the config rule database 108, respectively, to the host 102. The term “engine,” as used herein, generally refers to any combination of software, firmware, hardware, or other component that is used to effectuate a purpose.

The authentication engine 104 may be administered by the same admin who administers the host 102. Alternatively, an admin may be responsible for administering the authentication engine 104, and a lower level administrator may be responsible for administering the host 102. The latter would be more typical in a relatively large enterprise. It may be noted that the administrator of the authentication engine 104 might be able to crack at least some of the security of the host 102 (since the admin of the authentication engine 104 has access to the keys and config rules provided to the host 102), but the reverse is not necessarily true.

The file encryption engine 110 is coupled to the host 102. In an alternative embodiment, the file encryption engine 110 may be on the host 102. By “on the host” it is intended to mean that executable code of the file encryption engine 110 is stored on or off of the host 102 in secondary memory, and at least partially loaded into primary memory of the host 102 for execution by a processor, such as the processor 116.

The file encryption engine 110 may be referred to as including or sharing a computer-readable medium (e.g., memory), including executable software code stored in the computer-readable medium, and including or sharing a processor capable of executing the code on the computer-readable medium. As such, the file encryption engine 110 may be referred to as being embodied in a computer-readable medium.

In the example of FIG. 1, in operation, the host 102 authenticates files in its file system 112 with the authentication engine 104. The authentication engine 104 provides to the host 102 keys from the key database 106 and configuration rules from the config rule database 108. The file encryption engine 110 encrypts, in a first encryption mode, a subset of blocks of a file in the file system 112 using one or more of the keys and one or more of the configuration rules. The file encryption engine 110 then encrypts, in a second encryption mode, one or more of the blocks of the file. The first encryption mode may include using a block cipher in chained mode for all but a final (potentially partial) cipher block. The final (potentially partial) cipher block may be encrypted in the second encryption mode, which may include using a block cipher in a stream cipher mode.

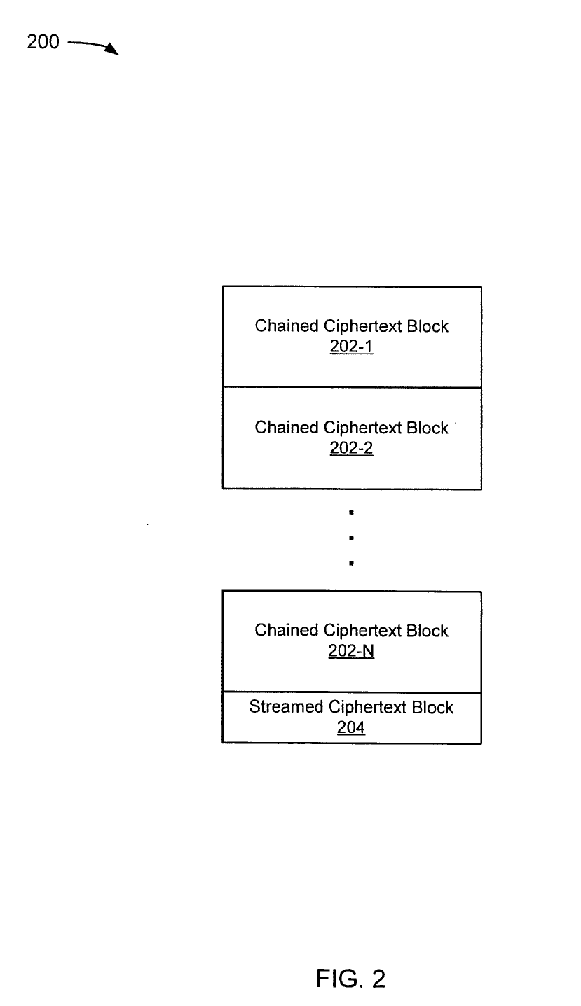

FIG. 2 depicts an example of an encrypted file 200. In the example of FIG. 2, the encrypted file 200 includes chained ciphertext blocks 202-1 to 202-N (referred to collectively as chained ciphertext blocks 202). The chained ciphertext blocks 202 are a subset of blocks associated with the encrypted file 200. The size of the subset depends upon the number of blocks, which is typically dependent upon the size of the file. In the example of FIG. 2, the encrypted file 200 includes a streamed ciphertext block 204. The streamed ciphertext block 204 may or may not be a partial block. In the example of FIG. 2, the streamed ciphertext block 204 is represented, for illustrative purposes only, as smaller than the chained ciphertext blocks 202 so as to illustrate that the streamed ciphertext block 204 may be a partial block. In an illustrative embodiment, there is only one streamed ciphertext block (the last block) for a file. However, in an alternative embodiment, multiple ciphertext blocks could be streamed.

The file 200 may include additional data, called metadata, associated with the file and/or the encryption. Thus, if the chained ciphertext blocks 202 have encryption overhead, the overhead can be stored in the file metadata. This may ensure that the file size of the file 200 remains the same before and after encryption.

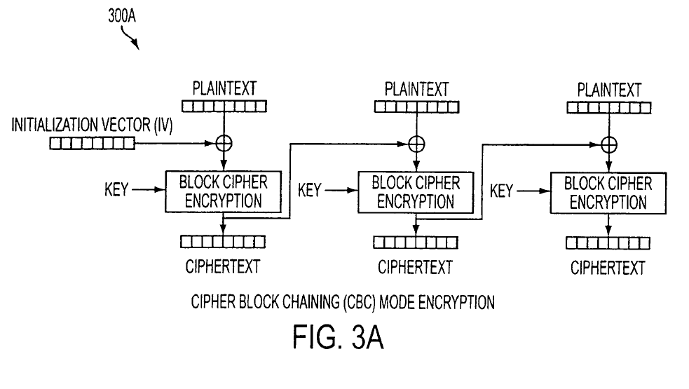

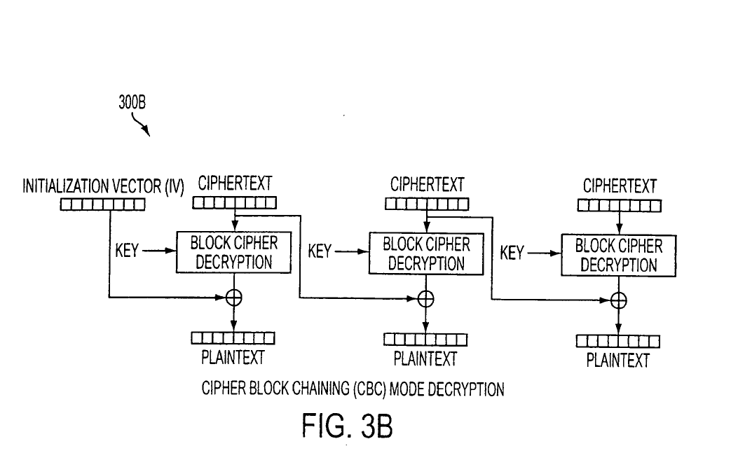

FIGS. 3A and 3B depict examples of how to respectively encrypt and decrypt the chained ciphertext blocks 202 in cipher block chaining (CBC) mode encryption. It may be noted that CBC is but one example of an encryption mode. Any applicable known or convenient technology could be used instead.

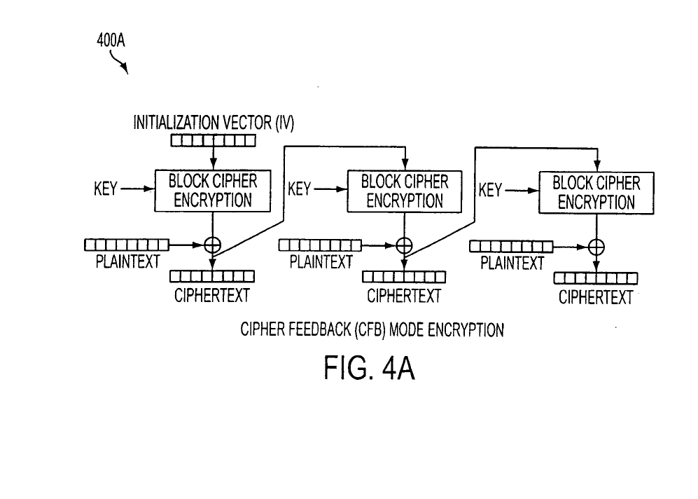

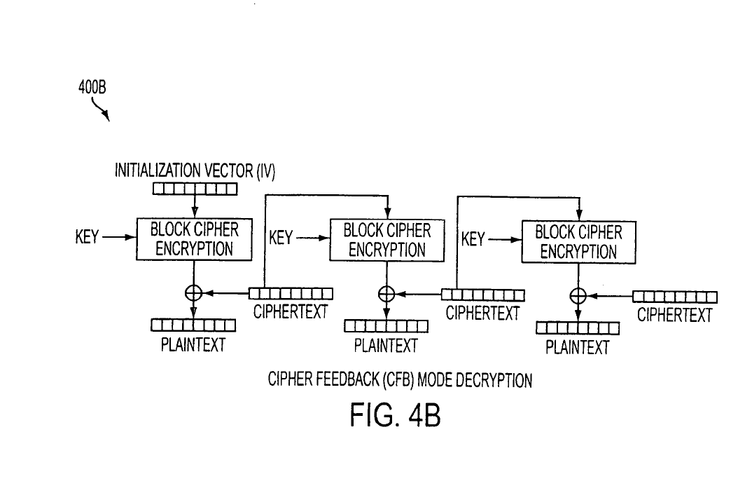

FIGS. 4A and 4B depict examples of how to respectively encrypt and decrypt the streamed ciphertext block 204 in cipher feedback (CFB) mode encryption. It may be noted that CFB is but one example of an encryption mode. CFB has at least two advantages over CBC mode: the block cipher is only ever used in the encrypting direction, and the message does not need to be padded to a multiple of the cipher block size. Any applicable known or convenient technology that is capable of encrypting the last block without padding could be used instead.

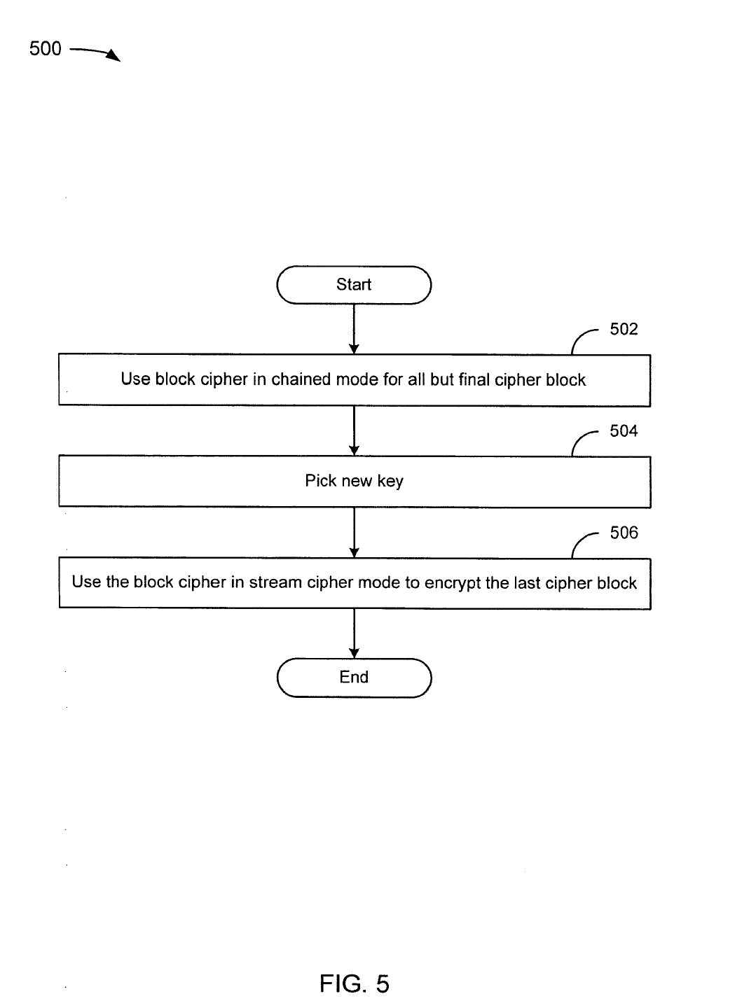

FIG. 5 depicts a flowchart 500 of an example of a method for encrypting a file. This method and other methods are depicted as serially arranged modules. However, modules of the methods may be reordered, or arranged for parallel execution as appropriate.

In the example of FIG. 5, the flowchart 500 starts at module 502 with using a block cipher in chained mode for all but a final cipher block. The chained mode may implement by way of example but not limitation CBC.

In the example of FIG. 5, the flowchart 500 continues to module 504 with picking a new key. Typically, it would be desirable to pick a new key for the last block each time it is encrypted. This would ensure that the last block is never encrypted twice with the same key. In many streaming mode implementations, this is a security risk.

In the example of FIG. 5, the flowchart 500 ends at module 506 with using a block cipher in streamed mode to encrypt the last cipher block. It may be noted that the last cipher block may or may not be a partial block.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and techniques described herein also relate to apparatus for performing the algorithms and techniques. This apparatus may be specially constructed for the required purposes, or it may comprise a general purpose computer selectively activated or reconfigured by a computer program stored in the computer. Such a computer program may be stored in a computer readable storage medium, such as, but is not limited to, read-only memories (ROMs), random access memories (RAMs), EPROMs, EEPROMs, magnetic or optical cards, any type of disk including floppy disks, optical disks, CD-ROMs, and magnetic-optical disks, or any type of media suitable for storing electronic instructions, and each coupled to a computer system bus.

As used herein, the term “embodiment” means an embodiment that serves to illustrate by way of example but not limitation.

It will be appreciated to those skilled in the art that the preceding examples and embodiments are exemplary and not limiting to the scope of the present invention. It is intended that all permutations, enhancements, equivalents, and improvements thereto that are apparent to those skilled in the art upon a reading of the specification and a study of the drawings are included within the true spirit and scope of the present invention. It is therefore intended that the following appended claims include all such modifications, permutations and equivalents as fall within the true spirit and scope of the present invention.

What is claimed is:

1. A system, comprising:
a host having a file stored in a file system of the host, wherein the file comprises of a plurality of blocks;
an authentication engine, which while in operation, provides one or more encryption keys and/or one or more configuration rules to the host;
a file encryption engine, which while in operation:
encrypts a first set of the plurality of blocks of the file in a first encryption mode using a first set of the one or more encryption keys and/or a first set of the one or more configuration rules;
encrypts a second set of the plurality of blocks of the file in a second encryption mode using a second set of the one or more encryption keys and/or a second set of the one or more configuration rules.

2. The system of claim 1, further comprising:
a key database operable to manage and store the one or more encryption keys.

3. The system of claim 1, further comprising:
a config rule database operable to manage and store the one or more configuration rules.

4. The system of claim 1, wherein:
the file also comprises a metadata associated with the file and/or the first and/or second mode of encryption.

5. The system of claim 4, wherein:
the metadata stores encryption overhead from encrypting the file under the first and/or second mode of encryption.

6. The system of claim 1, wherein:
the first and the second set of the one or more encryption keys are not identical.

7. The system of claim 1, wherein:
the first and the second set of the one or more configuration rules are not identical.

8. The system of claim 1, wherein:
the first set of the plurality of blocks are chained ciphertext blocks.

9. The system of claim 1, wherein:
the first encryption mode encrypts the first set of the plurality of blocks in cipher block chaining mode.

10. The system of claim 1, wherein:
the first set of the plurality of blocks includes all but a final block of the plurality of blocks of the file.

11. The system of claim 1, wherein:
the second encryption mode encrypts the second set of the plurality of blocks without padding the second set of the plurality of blocks in size.

12. The system of claim 1, wherein:
the second set of the plurality of blocks are streamed ciphertext blocks.

13. The system of claim 1, wherein:
the second encryption mode encrypts the second set of the plurality of blocks in cipher feedback mode.

14. The system of claim 1, wherein:
the first set of the plurality of blocks includes only a final block of the plurality of blocks of the file.

15. The system of claim 14, wherein:
the final block of the one or more blocks of the file is a partial block.

16. The system of claim 1, wherein:
the file encryption engine, while in operation:
decrypts the first set of the plurality of blocks of the file in the first encryption mode using the first set of the one or more encryption keys and/or the first set of the one or more configuration rules;
decrypts the second set of the plurality of blocks of the file in the second encryption mode using the second set of the one or more encryption keys and/or the second set of the one or more configuration rules.

17. A method, comprising:
choosing a first set of one or more encryption keys and/or a first set of one or more configuration rules;
encrypting a first set of a plurality of blocks of a file in a first encryption mode using the first set of the one or more encryption keys and/or the first set of the one or more configuration rules;
choosing a second set of the one or more encryption keys and/or a second set of the one or more configuration rules;
encrypting a second set of the plurality of blocks of the file in a second encryption mode using the second set of the one or more encryption keys and/or the second set of the one or more configuration rules.

18. The method of claim 17, further comprising:
managing and storing the one or more encryption keys via a key database.

19. The method of claim 17, further comprising:
managing and storing the one or more configuration rules via a config rule database.

20. The method of claim 17, further comprising:
encrypting the first and the second set of the plurality of blocks of files in different encryption modes.

21. The method of claim 17, further comprising:
encrypting the first and the second set of the plurality of blocks of files via different sets of encryption keys and/or different sets of configuration rules.

22. The method of claim 17, further comprising:
encrypting the first and the second set of the plurality of blocks, wherein the first set includes all but a final block of the file while the second set includes the file block of the file only.

23. The method of claim 17, further comprising:
storing encryption overhead from encrypting the file under the first and/or second mode of encryption.

24. A system, comprising:
means for choosing a first set of one or more encryption keys and/or a first set of one or more configuration rules;
means for encrypting a first set of a plurality of blocks of a file in a first encryption mode using the first set of the one or more encryption keys and/or the first set of the one or more configuration rules;
means for choosing a second set of the one or more encryption keys and/or a second set of the one or more configuration rules;
means for encrypting a second set of the plurality of blocks of the file in a second encryption mode using the second set of the one or more encryption keys and/or the second set of the one or more configuration rules, wherein the first and the second sets of the encryption keys and/or the first and the second set of the configuration rules are not identical.
